(19) United States
(12) Patent Application Publication
(10) Pub. No.: US 2002/0172507 A1
(43) Pub. Date: Nov. 21, 2002

(54) Method for preventing premature termination of video content

(75) Inventors: Thomas M. Stephany, Churchville, NY (US); Yawcheng Lo, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/860,733

(22) Filed: May 18, 2001

(51) Int. Cl. H04N 5/781

(52) U.S. Cl. 386/125; 386/126

(57) ABSTRACT

A method for preventing premature termination of video content, the method comprises the steps of creating the video content from data; creating a blank segment on a latter portion on the video content; and initiating digital writing for recording the video content on a recording media so that the blank segment remains on the latter portion of the video content for preventing premature termination of video content.

### FIELD OF THE INVENTION

The invention relates generally to the field of video CDs and, more particularly, to such video CDs having a blank frame at the end of its content for elimination of premature termination of the video content.

### BACKGROUND OF THE INVENTION

Commercially available video CDs, or VCDs, are digital movies formats for playing commercial movies on home players. A video CD looks the same as a music CD or CD-ROM, except that instead of music or software, it holds movies using compressed MPEG-1 video. Such VCDs are used to store a variety of video content using commercially available software.

Although the presently known and utilized method for storing video content on VCDs is satisfactory, there are drawbacks. In a portion of commercially available VCD players, premature termination may occur during playback wherein the video stream froze, or hung up, before the actual end of the video content. This freezing would typically last about 5 seconds.

Consequently, a need exists for a method of storing video content on VCDs in which such freezing is eliminated during playback.

### SUMMARY OF THE INVENTION

The present invention is directed to overcoming one or more of the problems set forth above. Briefly summarized, according to one aspect of the present invention, the invention resides in a method for preventing premature termination of video content, the method comprising the steps of (a) creating the video content from data; (b) creating a blank segment on a latter portion on the video content; and (c) initiating digital writing for recording the video content on a recording media so that the blank segment remains on the latter portion of the video content for preventing pre-mature termination of video content.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention has the advantage of eliminating premature termination of video CDs.

### BRIEF DESCRIPTION OF THE DRAWINGS

FIG. 1 is a flow diagram of the present invention.

### DETAILED DESCRIPTION OF THE INVENTION

In the following description, the present invention will be described in the preferred embodiment as a software program. Those skilled in the art will readily recognize that the equivalent of such software may also be constructed in hardware.

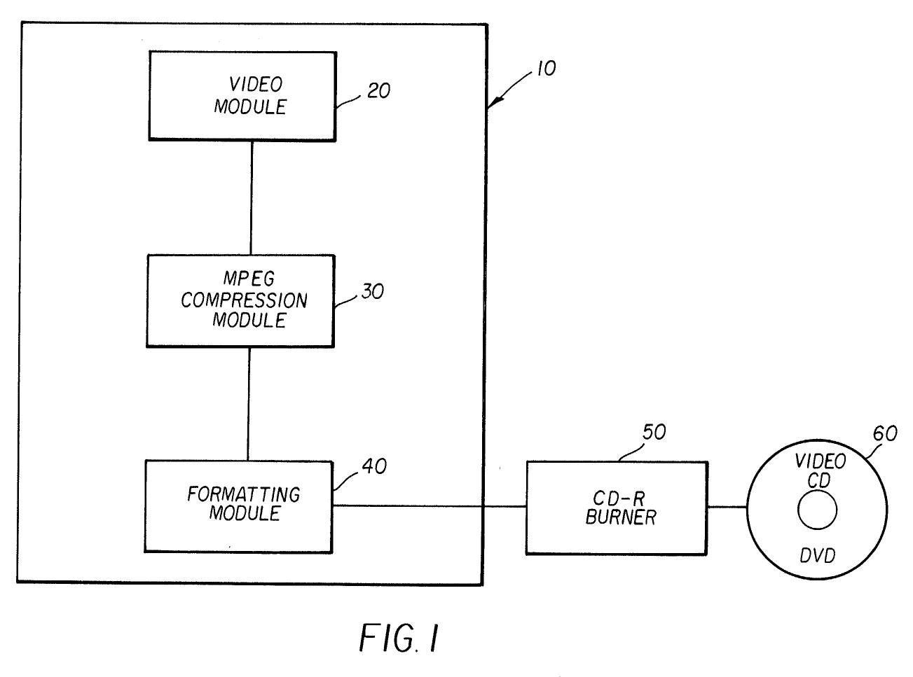

Referring to FIG. 1, there is shown a block diagram of the present invention. The present invention is implemented by a computer (not shown) and will not be discussed in detail herein. The invention includes a software program 10 for creating video from a series of photographs, for example photographs extracted from a roll of photographic negatives, which inserts a blank frame at the end portion, and then creates a video CD. The software program 10 includes as its first section a video module 20, which will add text, sound, and video streams, intermixed with still frames for creating multimedia productions. This module 20 may be, for example, VideoWave software from MGI Inc. of Toronto Canada. The video module 20 inserts a blank video frame at the end portion of the multimedia production to solve the problem of premature termination and momentary lock-up or freezing of the video. It is to be noted that the blank video frame may be of various durations according to the specific need.

This software program 10 further includes MPEG compression module 30, which will compress the video stream, as is well-known art into standard MPEG format. The software program 10 also includes a formatting module 40 which creates the file structures necessary for a standalone player, such as a dual purpose DVD/VCD player commercially available, to recognize this to be created disk as a video CD. For example, a software package known as Nero may be used as this module. The formatting module 40 has the capabilities of instructing a CD-R burner 50, such as those that are commercially available, to write or produce a CD-R disk, thus producing a working video CD 60. It is also possible to produce a DVD with the same blank video frame. It is instructive to note that the time variable of the blank frame is maintained when the content is recorded. Such CD-R burners are commercially available and known to those skilled in the art and will not be discussed in detail herein.

The invention has been described in detail with particular reference to certain preferred embodiments thereof, but it will be understood that variations and modifications can be effected within the spirit and scope of the invention.

What is claimed is:

1. A method for preventing premature termination of video content, the method comprising the steps of:
(a) creating the video content from data;
(b) creating a blank segment on an end portion on the video content; and
(c) initiating digital writing for recording the video content on a recording media so that the blank segment remains on the latter portion of the video content for preventing pre-mature termination of video content.

2. The method of claim 1 further comprising (d) applying a time variable to the blank segment wherein the variable can be adjusted for optimum performance.

3. The method of claim 2, wherein step (d) includes maintaining the time variable when the video content is recorded on the recording media.

4. A computer program product for preventing premature termination of video content comprising: a computer readable storage medium having a computer program stored thereon for performing the steps of:
(a) creating the video content from data;
(b) creating a blank segment on an end portion on the video content; and
(c) initiating digital writing for recording the video content on a recording media so that the blank segment remains on the latter portion of the video content for preventing pre-mature termination of video content.

5. The computer program product as in claim 4 further comprising the step of (d) applying a time variable to the blank segment wherein the variable can be adjusted for optimum performance.

6. The computer program product as in claim 5, wherein step (d) includes maintaining the time variable when the video content is recorded on the recording media.
